(19) United States
(12) Patent Application Publication
(10) Pub. No.: US 2017/0013346 A1
(43) Pub. Date: Jan. 12, 2017

(54) ELECTRONIC DEVICE AND METHOD FOR CONTROLLING POWER SIGNAL USING THE SAME

(71) Applicant: Samsung Electronics Co., Ltd., Gyeonggi-do (KR)

(72) Inventors: Changsu LEE, Gyeonggi-do (KR); Sungsoo MOON, Gyeonggi-do (KR); Kemsuk SEO, Gyeonggi-do (KR); Bongjae RHEE, Gyeonggi-do (KR); Sangmoon LEE, Gyeonggi-do (KR); Jihun HEO, Gyeonggi-do (KR)

(21) Appl. No.: 15/201,788

(22) Filed: Jul. 5, 2016

(30) Foreign Application Priority Data
Jul. 9, 2015 (KR) 10-2015-0097799

(51) Int. Cl. H04R 1/10; H04W 76/02; H04W 4/00

(52) U.S. Cl. CPC H04R 1/1041; H04W 4/008; H04W 76/023; H04R 1/1025; H04R 2460/03; H04R 2420/07

(57) ABSTRACT

An electronic device according to various embodiments of the present disclosure may include a communication module configured to communicate wirelessly with an external device; an ear jack configured to include at least one ear jack terminal; an audio processing unit configured to process an audio signal; and a control unit configured to: detect a coupling with the external device through the ear jack, determine whether the electronic device is in a power transmission mode, control the audio processing unit to generate an ear jack signal when the electronic device is in a power transmission mode, output the ear jack signal by amplifying the ear jack signal so that power is supplied to the coupled external device, and to output the audio signal to the ear jack terminal when the electronic device is not in a power transmission mode.

### CLAIM OF PRIORITY

This application claims priority from and the benefit under 35 U.S.C. §119(a) of Korean Patent Application No. 10-2015-0097799, filed on Jul. 9, 2015, which is hereby incorporated by reference for all purposes as if fully set forth herein.

### TECHNICAL FIELD

The present disclosure relates to electronic devices and methods for controlling a power signal using the same and, more particularly, to electronic devices and methods for controlling a power signal from an electronic device having an ear jack to a peripheral device, such as Bluetooth headsets.

### BACKGROUND

Bluetooth communication is a wireless connection technology enabling bidirectional data transmission and reception in real time within a short range. Bluetooth communication connects wirelessly with low power; therefore, the usability of Bluetooth communication is improved because power consumption of wireless communication is low. For example, Bluetooth headsets and earphones are being continuously developed in the field of Bluetooth technology because they can provide the function of a personal speaker and a free activity by synchronizing with an electronic device.

Bluetooth devices require separate power source to drive its communication module for transmitting and receiving wireless data. Typically, Bluetooth devices are powered with battery sources, which creates an inconvenience to the user due to limited battery capacity. Further, batteries of Bluetooth devices are generally charged using terminals such as USB ports. Therefore, it is also inconvenient to carry a charging cable to recharge the Bluetooth device.

### SUMMARY

According to one embodiment of the present disclosure, an electronic device, such as a mobile phone, and a method of Bluetooth charging using the same are provided so that battery power of the electronic device can be supplied to a Bluetooth device by using an ear jack.

According to another embodiment of the present disclosure, a Bluetooth device is provided whose battery or operating power can be charged or received through an ear jack of the electronic device, such as a mobile phone.

An electronic device according to one embodiment of the present disclosure may include a communication module configured to communicate wirelessly with an external device; an ear jack configured to include at least one ear jack terminal; an audio processing unit configured to process an audio signal; and a control unit configured to: detect a coupling with the external device through the ear jack, determine whether the electronic device is in a power transmission mode, control the audio processing unit to generate an ear jack signal when the electronic device is in a power transmission mode, output the ear jack signal by amplifying the ear jack signal so that power is supplied to the coupled external device, and to output the audio signal to the ear jack terminal when the electronic device is not in a power transmission mode.

A Bluetooth electronic device according to one embodiment of the present disclosure may include a Bluetooth module configured to transmit and receive Bluetooth communication data; a jack connector configured to include at least one terminal for coupling to an ear jack of an external device and to receive an analog ear jack signal or an audio signal; a rectifying circuit configured to convert the analog ear jack signal to a digital signal; and a processing unit configured to power the Bluetooth module or charge a battery of the Bluetooth electronic device using power supplied by the digital signal.

A method for controlling a power signal in an electronic device using an ear jack according to one embodiment of the present disclosure may include detecting a coupling with an external device through the ear jack; determining whether the electronic device is in a power transmission mode; generating an ear jack signal to output to the ear jack terminal when the electronic device is in a power transmission mode; outputting the generated ear jack signal to the ear jack terminal by amplifying the ear jack signal; and outputting an audio signal to the ear jack terminal when the electronic device is not in a power transmission mode.

A method for controlling a power signal in a Bluetooth electronic device using an ear jack connector according to various embodiments of the present disclosure may include receiving an analog signal or an audio signal via the ear jack connector from an external device; converting the received analog signal to a digital signal with a rectifying circuit; and driving a Bluetooth module of the Bluetooth electronic device or charging a battery of the Bluetooth electronic device using power supplied by the digital signal.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to one embodiment of the present disclosure;

FIG. 2 is a schematic drawing illustrating a connection environment between an electronic device and a Bluetooth device according to one embodiment of the present disclosure;

FIG. 3 is a block diagram illustrating a configuration of a Bluetooth device according to one embodiment of the present disclosure;

FIG. 4A, FIG. 4B and FIG. 4C are schematic drawings illustrating a connection structure of a jack plug in a Bluetooth headset according to one embodiment of the present disclosure;

FIG. 5 is a flowchart illustrating a method for controlling a power signal in an electronic device according to one embodiment of the present disclosure;

FIG. 6 is a flowchart illustrating a method for controlling a power signal in a Bluetooth device according to one embodiment of the present disclosure;

FIG. 7 is a flowchart illustrating a method for controlling a power signal in a Bluetooth device according to one embodiment of the present disclosure;

FIG. 8 is a block diagram illustrating a configuration of an electronic device according to one embodiment of the present disclosure; and

FIG. 9 is a block diagram illustrating a configuration of a program module according to one embodiment of the present disclosure.

### DETAILED DESCRIPTION

Hereinafter, embodiments of the present disclosure will be described in detail with reference to the accompanying drawings. It will be easily appreciated to those skilled in the art that various modifications, additions and substitutions are possible from the embodiment of the present disclosure, and the scope of the invention should not be limited to the following embodiments. The embodiments of the present disclosure are provided such that those skilled in the art completely understand the invention. In the drawings, the same or similar elements are denoted by the same reference numerals even though they are depicted in different drawings.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of the addition of one or more other characteristics, numbers, steps, operations, constituent elements, components or combinations thereof.

In the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., and/or the like, may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although for both of them the first user device and the second user device are user devices. For example, a first element could be termed a second element, and similarly, a second element could be also termed a first element without departing from the scope of the present disclosure.

In the case where according to which a component is referred to as being “connected” or “accessed” to other component, it should be understood that not only the component is directly connected or accessed to the other component, but also another component may exist between the component and the other component. Meanwhile, in the case where according to which a component is referred to as being “directly connected” or “directly accessed” to other component, it should be understood that there is no component therebetween.

The terms used in the present disclosure are only used to describe specific various embodiments, and are not intended to limit the present disclosure. Singular forms are intended to include plural forms unless the context clearly indicates otherwise.

Unless otherwise defined, all terms including technical and/or scientific terms used herein have the same meaning as commonly understood by one of ordinary skill in the art to which the invention pertains. In addition, unless otherwise defined, all terms defined in generally used dictionaries may not be overly interpreted.

The electronic device according to the embodiments of the present disclosure may be a device including a communication function. For example, the electronic device corresponds to a combination of at least one of the followings: a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player (e.g., MP3 player), a mobile medical device, a camera, or a wearable device. Examples of the wearable device are a head-mounted-device (HMD) (e.g., electronic eyeglasses), electronic clothing, an electronic bracelet, an electronic necklace, an appcessory, an electronic tattoo, a smart watch, etc.

The electronic device according to the embodiments of the present disclosure may include at least one of the following: the smart home appliances are a television (TV), a Digital Video Disk (DVD) player, an audio system, a refrigerator, an air-conditioner, a cleaning device, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, an electronic album, or the like.

The electronic device according to the embodiments of the present disclosure may include at least one of the following: medical devices (e.g., Magnetic Resonance Angiography (MRA), Magnetic Resonance Imaging (MRI), Computed Tomography (CT), a scanning machine, an ultrasonic scanning device, etc.), a navigation device, a Global Positioning System (GPS) receiver, an Event Data Recorder (EDR), a Flight Data Recorder (FDR), a vehicle infotainment device, an electronic equipment for ships (e.g., navigation equipment, gyrocompass, etc.), avionics, a security device, a head unit for vehicles, an industrial or home robot, an automatic teller's machine (ATM), a point of sales (POS) system, etc.

The electronic device according to the embodiments of the present disclosure may include at least one of the following: furniture or a portion of a building/structure, an electronic board, an electronic signature receiving device, a projector, various measuring instruments (e.g., a water meter, an electric meter, a gas meter and a wave meter), etc., which are equipped with a heart rate measuring function, respectively. The electronic device according to the embodiments of the present disclosure may also include a combination of the devices listed above. In addition, the electronic device according to the embodiments of the present disclosure may be a flexible device. It is obvious to those skilled in the art that the electronic device according to the embodiments of the present disclosure is not limited to the aforementioned devices.

Hereinafter, electronic devices according the embodiments of the present disclosure are described in detail with reference to the accompanying drawings. In the description, the term a ‘user’ may be referred to as a person or a device that uses an electronic device, e.g., an artificial intelligent electronic device.

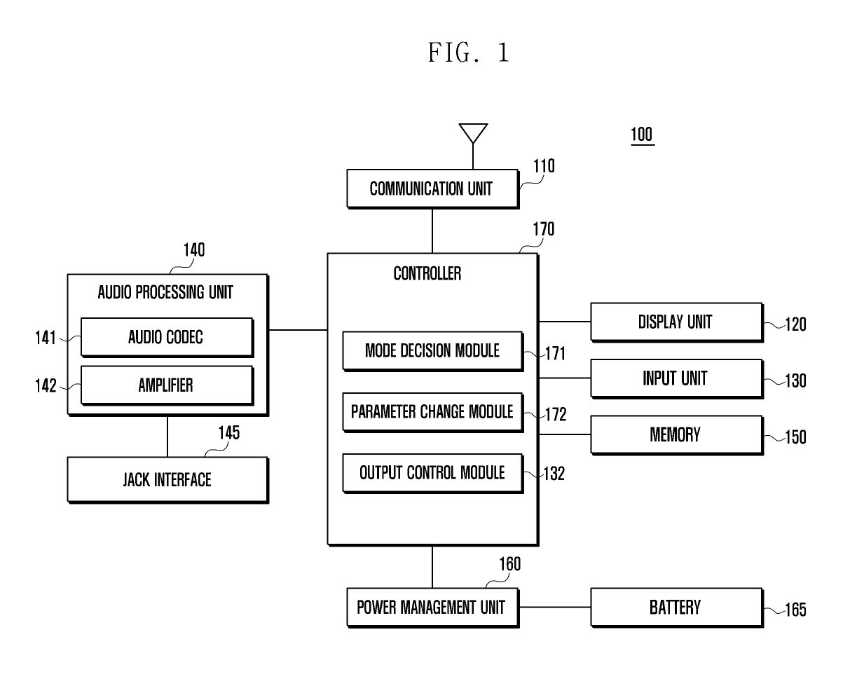

FIG. 1 is a block diagram of an electronic device, according to an embodiment of the present disclosure.

Referring to FIG. 1, the electronic device 100 is provided. The electronic device 100 includes a communication unit 110, a display unit 120, an input unit 130, an audio processing unit 140, a jack interface 145, a memory 150, a power management unit 160, a battery 165 and a controller 170.

The communication unit 110 is connected with a network through wired/wireless communication to perform voice communication, video communication, or data communication with external devices (e.g., other electronic devices, a server, etc.) under the control of the controller 170. The controller 170 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc.

The wireless communication includes at least one of, for example, WiFi, Bluetooth (BT), Near Field Communication (NFC), a Global Positioning System (GPS), or cellular communication (e.g., Long Term Evolution (LTE), LTE-A, Code Division Multiple Access (CDMA), Wideband CDMA (WCDMA), Universal Mobile Telecommunication System (UMTS), Wireless Broadband (WiBro), and Global System for Mobile (GSM) communication). The wired communication includes at least one of, for example, a Universal Serial Bus (USB), a High Definition Multimedia Interface (HDMI), Recommended Standard 232 (RS-232), or a Plain Old Telephone Service (POTS).

The display unit 120 displays images and data to a user, for example, a graphic user interface. The display unit 120 includes a display panel. For example, the display panel may adopt a Liquid Crystal Display (LCD), or an Active Matrix-Organic Light Emitting Diode (AM-OLED). The display unit 120 includes a controller that controls the display panel. The display panel may be configured to be flexible, transparent, or wearable. The display unit 120 may be combined with a touch panel as a module (e.g., a touch screen).

The input unit 130 includes a touch panel, a pen sensor, and keys. The touch panel recognizes a user's touch input in a manner of a capacitive type, a pressure type, an infrared type, or an ultrasonic type. The touch panel may include a controller. The touch panel provided in the capacitive type may detect proximity as well as a touch. The pen sensor may be implemented, for example, by a pen recognition panel, and operates in the same manner as the user touch recognition. The keys may include mechanical keys or touch keys.

The audio processing unit 140 transmits and receives audio signals, and performs encoding and decoding of the same. The audio processing unit 140 is connected with a microphone and a speaker and/or an ear jack to convert voice signals input from the microphone into data to be transmitted. The audio processing unit 140 also converts voice signals into analog signals to be output through the speaker or ear jack. The audio processing unit 140 outputs various audio signals (e.g., audio signals by reproducing MP3 files or video files) that are created in the electronic device through the speaker. The audio processing unit 140 may including a audio codec 141 to perform encoding and decoding audio signal and/or voice signal and a amplifier 142 to amplify the audio signal and/or voice signal with a particular gain. Here, the gain may represent a change in amplitude or power of the input and output signals.

The audio codec 141 may convert an inputted analog signal to a digital signal for storing data or convert the digital signal to an analog signal for outputting the audio signal and/or voice signal. The amplifier 142 may be circuitry for amplifying input signal to a maximum power level allowed by the electronic device 100. The control unit 170 may control the amplifier 142 to amplify the analog signal to a specific level by changing parameters of the amplifier 142. The ear jack interface 145 may connect the electronic device to the external device (e.g., ear phone, headset) using wired communication. The ear jack interface 145 may include one or more ear jack terminals for transmitting and receiving audio signals in connection with the external device. For example, the ear jack interface 145 may include a left sound terminal (L), a right sound terminal (R), a microphone terminal (M) and a ground terminal (G).

According to an embodiment of the present disclosure, the ear jack interface 145 may pass an audio signal generated from the audio processing unit 140 on to the earphone and pass a microphone signal from a microphone of the earphone on to the audio processing unit 140.

The memory 150 stores instructions or data, which are received from the controller 170 or other elements of the electronic device 100 (e.g., the display unit 120, the input unit 130, and the communication unit 110). For example, the memory 150 may store an operating system for booting the electronic device 100, instructions for one or more operations described above, one or more applications, messages transmitted and received through the network, data resulting from the execution of the applications, etc.

The memory 150 may include programming modules, such as a kernel, middleware, an application programming interface (API), and applications. The programming modules alternatively may be configured as software, firmware, hardware, or a combination thereof.

The memory 150 may include at least one of the internal memory and an external memory and may be volatile or non-volatile memory. The internal memory may include at least one of a volatile memory (e.g. Dynamic Random Access Memory (DRAM), Static RAM (SRAM), Synchronous Dynamic RAM (SDRAM) or a non-volatile memory (e.g. One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, and NOR flash memory)

According to an embodiment, the internal memory may be a Solid State Drive (SSD). The external memory may be a flash drive such as Compact Flash (CF), Secure Digital (SD), micro-SD, Mini-SD, extreme Digital (xD), and Memory Stick. The external memory may be connected to the electronic device 100 through various interfaces functionally. According to an embodiment, the electronic device 100 may include a storage device (or storage medium) such as hard drive or flash storage.

The power management unit 160 may control supplying power related to operations of the electronic device 100, and to charge the battery 165. The power management unit 160 may control to prevent overvoltage or overcurrent in elements of the electronic device 100.

The controller 170 receives instructions from other elements of the electronic device 100 mentioned above (e.g., the communication unit 110, the display unit 120, the input unit 130, the audio processing unit 140, the jack interface 145, and the memory 150), and decodes the received instructions to perform a calculation or a data process according to the decoded instructions. For example, when electrical power is applied to the electronic device 100, the controller 170 controls a process of booting the electronic device 100, and may execute various applications, which are stored in a program area of the memory 150, to perform functions according to a user's setup of the electronic device 100. The controller 170 may include one or more application processors (AP), or one or more communication processors (CP).

According to various embodiments of the present disclosure, the control unit 170 may include a mode decision module 171, parameter change module 172, and output control module 173. The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

If an external device, for example a Bluetooth headset, is connected through the ear jack interface 145, the mode decision module 171 can identify whether a sound output mode or a power transmission mode is set for the external device, and provide mode information for the parameter change module 172.

According to an embodiment of the present disclosure, the mode decision module 171 can identify whether the electronic device is connected with the external device through Bluetooth pairing and can determine the power transmission mode if the external device is connected through the Bluetooth pairing.

According to an embodiment of the present disclosure, if an input signal is received from the external device through the ear jack interface 145, the mode decision module 171 can determine the power transmission mode based on the input signal. Here, the input signal may be a signal of a voltage value (or resistance value) generated according to the connection between the ear jack interface 145 and the external device. However, the present disclosure is not so limited.

According to an embodiment of the present disclosure, the mode decision module 171 can determine the power transmission mode, if one of a plurality of terminals in the ear jack interface is electrically connected to a connection terminal of the external device and another terminal is electrically disconnected from the external device.

According to an embodiment of the present disclosure, the mode decision module 171 can control to display information for changing to the power transmission mode in the display unit 120 if the external device is connected through an ear jack interface and can determine the power transmission mode if a user input for changing to the power transmission mode is detected via, for example, touch input.

The parameter change module 172 can adjust an output level of an analog signal by changing a parameter of the amplifier 142 based on mode information determined by the mode decision module 171.

If the power transmission mode is determined based on the connection of the external device through the ear jack interface 145, the parameter change module 172 can change a parameter of the amplifier 142 so that a signal can be amplified to a specific power level, for example the maximum power level allowed by the electronic device.

The electronic device according to one embodiment of the present disclosure can supply power to the external device by amplifying a signal transmitted through a power line of the electronic device to a maximum level with the amplifier 142 and transmitting the amplified signal to the external device.

The following table shows a relationship between output voltage, power, and decibel levels at 1 kHz output, with the maximum level shown in bold.

TABLE 1

| V | mV | mW | dB |
|---|---|---|---|
| 0.0006 | 0.6 | 0.00001125 | −49.4885 |
| 0.035 | 35 | 0.03828125 | −14.1701 |
| 0.27 | 270 | 2.278125 | 3.575775 |
| 0.55 | 550 | 9.453125 | 9.755754 |

As shown in Table 1, the electronic device can generate power of approximately 9.45 mW if an analog signal is amplified to a maximum output 550 mV through an ear jack terminal, and the electronic device can generate power of approximately 18.9-20 mW if the analog signal is amplified to the maximum output level through 2 ear jack terminals.

The maximum output level of analog signal can be changed according to a specification of an audio codec included in the electronic device; and, if a signal output level according to the audio codec becomes higher, a power amount supplied to the external device may increase proportionally.

According to an embodiment of the present disclosure, if a sound output mode is determined for the external device based on the connection of the external device through the ear jack interface 145, the parameter change module 172 can control to change a parameter of the amplifier so that a corresponding audio signal can be generated. In the sound output mode, the parameter change module 172 can change the parameter so that an amplifying level of the audio signal corresponds to a sound volume level.

If the external device is connected through the ear jack interface 145, the output control module 173 can control the audio processing unit 140 to output an analog sound signal with a corresponding sound output level to the external device connected to the ear jack interface 145 or to output the analog signal with the maximum power level.

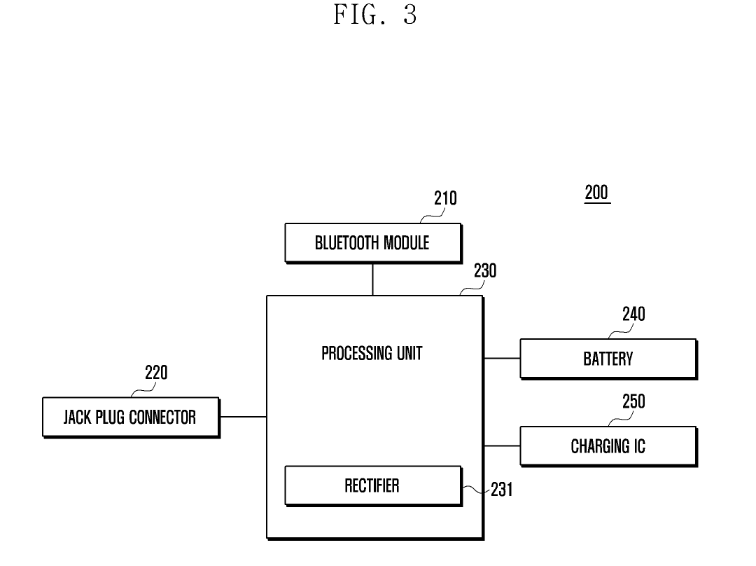

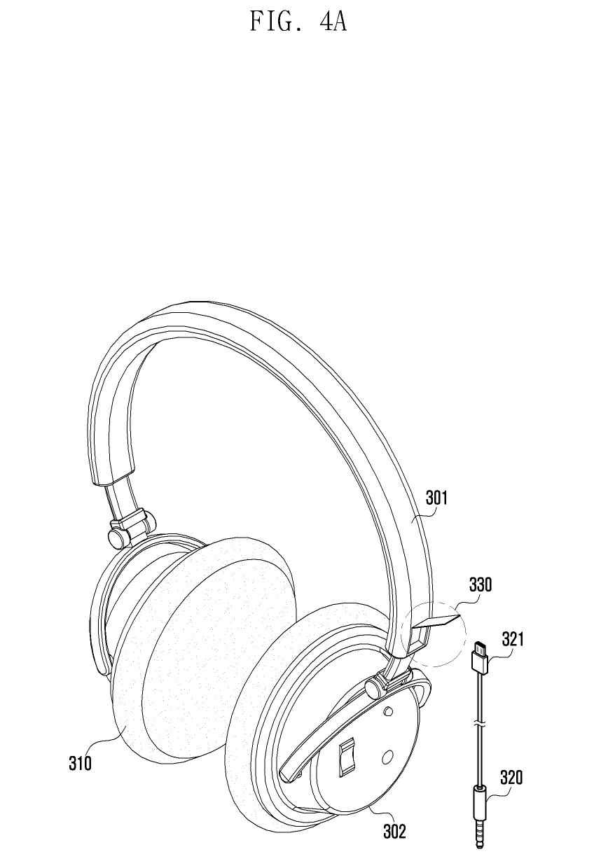

According to an embodiment of the present disclosure, in a power supply mode, the output control module 173 can generate an analog signal corresponding to at least one of a left sound terminal and a right sound terminal by converting a digital signal transmitted to a power line through the audio codec 141, and transmit the analog signal to the ear jack interface 145 by amplifying to a maximum power level with the amplifier 142. Subsequently, the electronic device 100 can transmit the analog signal amplified to the maximum power level to an external device (for example, Bluetooth device) connected to an ear jack terminal of the ear jack interface 145. The Bluetooth device can charge a battery of the Bluetooth device or control to drive a Bluetooth module with a DC voltage by converting the analog signal amplified through a jack plug connector connected with the ear jack interface 145 to a digital signal. A detailed configuration of the Bluetooth device will be described in FIG. 3.

According to an embodiment of the present disclosure, in the sound output mode, the output control module 173 can generate an audio signal corresponding to audio data through an audio code and transmit the audio signal to the ear jack interface 145 by amplifying to a corresponding sound output level. Subsequently, the electronic device 100 can transmit the audio signal to an audio output device connected to the ear jack interface 145. The operation of the sound output mode is well known to those skilled in the art; therefore, detailed descriptions are omitted here.

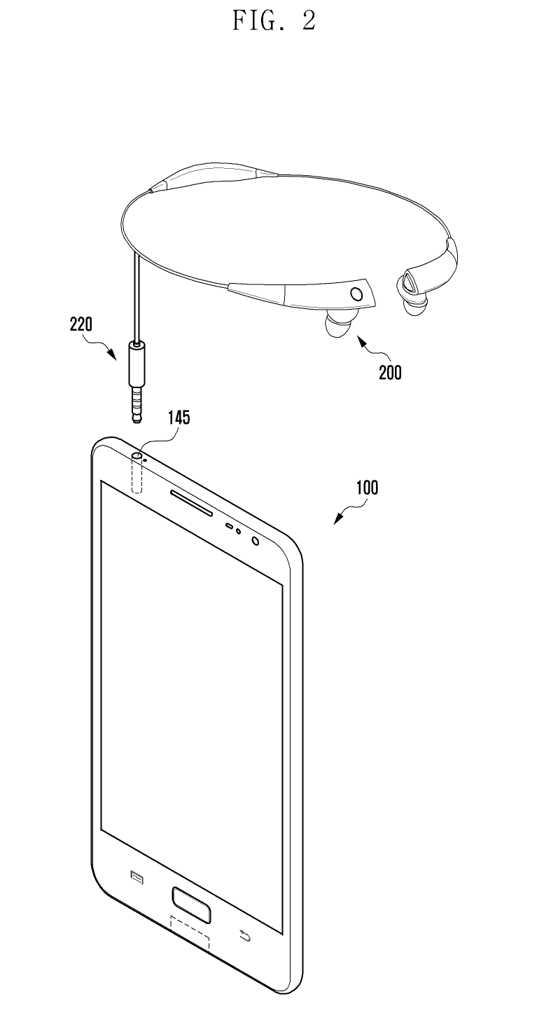

FIG. 2 is a schematic drawing illustrating a connection environment between an electronic device and a Bluetooth device according to one embodiment of the present disclosure.

Referring to FIG. 2, the electronic device 100 according to various embodiments of the present disclosure can be used as a power supply means for an external device 200 as well as an input/output means for an audio signal of an ear jack.

The electronic device 100 according to various embodiments of the present disclosure may include an ear jack interface 145, and the external device 200, for example a Bluetooth device may include a jack plug connector 220 including connection terminals which can be inserted into the ear jack interface 145 of the electronic device 100.

The jack plug connector 220 may include at least one connection terminal which can receive a signal by contacting with an ear jack terminal of the ear jack interface 145. For example, the connection terminal may include a right sound terminal (R signal), left sound terminal (L signal), and ground terminal (G signal).

The electronic device 100 can identify insertion of the jack plug connector 220 into the ear jack interface 145 through a voltage generated by a contact between the connection terminal of the jack plug connector 220 and the ear jack terminal.

If the jack plug connector 220 of the Bluetooth device 200 is inserted into the ear jack interface 145, the electronic device 100 can transmit an analog signal to the Bluetooth device 200 through the ear jack. The analog signal can supple power to the Bluetooth device 200 by being amplified, for example, to a maximum output level. The Bluetooth device 200 can receive the amplified analog signal from the electronic device through the jack plug connector 220, convert the analog signal to a digital signal through a rectifying circuit, and charge a battery of the Bluetooth device or drive a Bluetooth module by transmitting a DC voltage of the converted digital signal to a charging circuit.

Hereafter, a configuration of a Bluetooth device is described referring to FIG. 3.

FIG. 3 is a block diagram illustrating a configuration of a Bluetooth device according to one embodiment of the present disclosure.

Referring to FIG. 3, the Bluetooth device 200 according to various embodiments of the present disclosure may include a Bluetooth module 210, jack plug connector 220, processing unit 230, BT (Bluetooth) battery 240, and charging IC (Integrated Circuit) 250. The Bluetooth device may be a portable Bluetooth device such as a Bluetooth headset, Bluetooth earphone, or Bluetooth speaker.

The Bluetooth module 210 can transmit and receive Bluetooth communication data to/from the electronic device. The Bluetooth module 210 can transmit wireless communication data packets by modulating and amplifying to a predetermined frequency band, or transmit data packets to the processing unit 230 by reducing noise of the received frequency signal, amplifying the signal of the predetermined frequency band, and processing to a lower frequency band.

The jack plug connector 220 can connect the Bluetooth device 200 to an electronic device through an ear jack interface, as shown in FIG. 2. The jack plug connector 220 may transmit the received analog signal the processing unit 230, which in turn may rectify the signal using a rectifier 231.

The jack plug connector 220 may include connection terminals such as a right sound terminal (R signal), left sound terminal (L signal), and ground terminal (G signal) which are connected to an ear jack terminal of the electronic device. According to an embodiment of the present disclosure, the jack plug may further include a microphone terminal (M signal), if the Bluetooth device 200 includes a microphone.

According to an embodiment of the present disclosure, one of the jack plug terminals may be coated with an insulating material or formed with a non-conductive material for an electrical insulation, For example, the insulation coating may be formed with sapphire, quartz, or DLC (Diamond-like Carbon).

The processing unit 230 can control a Bluetooth connection with an electronic device and functions of calculating, storing, and processing Bluetooth data received through the Bluetooth module.

According to an embodiment of the present disclosure, the processing unit 230 can control to supply a DC voltage to the Bluetooth module 210 by converting an analog signal received from the electronic device through the jack plug to a digital signal with the rectifier 231, or to charge the battery 240 through the charging IC 250.

The rectifier 231 is connected with a jack plug connector and can supply power to a battery by converting an analog signal received from the jack plug to a digital signal and transmitting a DC voltage to a charging circuit through a power line.

According to an embodiment of the present disclosure, if insertion of the jack plug connector 220 into the ear jack of the electronic device 100 is detected, the processing unit 230 can identify a connection state of Bluetooth pairing and control to drive the Bluetooth module 210 with the power generated according to the signal transmitted from the jack plug connector 220 if the electronic device 100 and the Bluetooth device 200 are paired.

If the electronic device 100 and the Bluetooth device 200 are not paired, the processing unit 230 can control to charge the Bluetooth battery 240.

The charging IC 250 can charge a battery by using electric power transmitted from the rectifier 231 or transmitted from a power supply module (not shown). The charging IC 250 may have a function of protecting an inflow of overvoltage or overcurrent.

The battery 240 can store or generate electric power and supply the electric power to the Bluetooth device 200.

According to an embodiment of the present disclosure, in case that the Bluetooth device 200 is a Bluetooth headset or earphone, the Bluetooth device 200 may further include an audio output unit (for example, speaker; not shown) which outputs an analog signal received from the Bluetooth module 210.

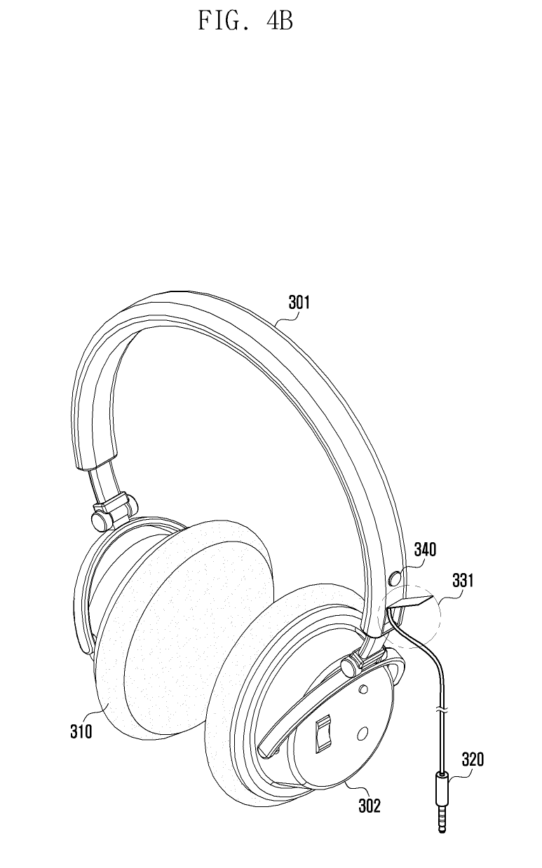

FIGS. 4A to 4C are schematic drawings illustrating a connection structure of a jack plug in a Bluetooth headset according to one embodiment of the present disclosure.

Referring to FIGS. 4A to 4C, the jack plug connector 220 may be manufactured to be integrated with the Bluetooth device or be detachable. Hereafter, the Bluetooth device 200 is assumed to be a Bluetooth headset; however, this is merely an example and the present disclosure is not limited to this example.

The Bluetooth headset may be formed in an ear type which can be worn on ears, neck type which can be worn on a neck, or head type which can be worn on a head.

The Bluetooth headset shown in FIG. 4A is a head type and can be divided into a frame 301 which can be fixed on a part of a user's body (for example, the head), headset body 302, and a headset speaker 310 for outputting an audio sound transmitted from the headset body.

The headset body 302 may be formed by including components of the Bluetooth device shown in FIG. 3, such as a Bluetooth module 210, processing unit 230, battery 240, and charging IC 250. The Bluetooth module included in the headset body 302 can receive Bluetooth data from the electronic device, and transmit an audio sound to the headset speaker 310 by processing the received data.

The headset speaker 310 can output the audio sound received from the headset body 302. Detailed structures of the frame 301, headset body 302, and headset speaker 310 of the Bluetooth device are well known to those skilled in the art and therefore omitted here.

According to an embodiment of the present disclosure, a jack plug connector (or jack plug cable) is a portable accessory, and a jack plug unit 320 to be combined with an ear jack interface and a connection terminal 321 to be combined with a connection terminal unit 330 of a Bluetooth device may be configured in a cable form as shown in FIG. 4A. The Bluetooth device may be formed to include a connection terminal unit 330 in which the detachable jack plug cable can be inserted. The electronic device and the Bluetooth device can be connected by inserting the jack plug unit 320 into the ear jack interface of the electronic device and inserting the connection terminal 321 into the connection terminal unit 330 of the Bluetooth device. In one embodiment, the connection terminal unit 330 of the Bluetooth device is formed in a structure of connecting to an rectifier of the headset body 302, and an analog signal can be transmitted from the connection terminal 321 to the rectifier. The Bluetooth device shown in FIG. 4A can receive an analog signal amplified to, for example, a maximum output level from the ear jack terminal of the electronic device through the connection terminal unit 330, and can supply power to the Bluetooth device by converting the analog signal to a digital signal with the rectifier.

According to another embodiment of the present disclosure, the Bluetooth device may be formed so that the jack plug cable 331 is inserted into the headset as shown by FIG. 4B. In this case, the jack plug cable 331 can be inserted into the Bluetooth device or pulled out from the Bluetooth device if necessary. The Bluetooth device may further include a cord reel so that the jack plug cable 331 pulled out can be reinserted into the Bluetooth device.

For example, an operating means of the cord reel may include a cord reel button 340 for winding the jack plug connector into the body of the Bluetooth device so that the pulled out jack plug connector 320 can be automatically reinserted into the Bluetooth device if the cord reel button shown in FIG. 4B is pressed.

As another example, the operating means of the cord reel may not include the cord reel button 340 and can be formed in a structure whereby the jack plug cable 331 is extracted if pulled once and reinserted automatically into the Bluetooth device if pulled once again.

Detailed descriptions on the operating means of the cord reel will be omitted here because the structure of the operating means is well known to those skilled in the art.

According to another embodiment of the present disclosure, the Bluetooth headset shown in FIG. 4C is an ear headphone formed in an ear type. The Bluetooth device of ear type can be formed so that a connection part of the ear headphone can be used as a jack plug cable. Referring to FIG. 4C, a head part 360 and a connection line 362 connected to a headset body can be separated, and an end of the connection line 362 may be formed to have a jack plug connector 363. By using the jack plug 363 of FIG. 4C, the Bluetooth headset can receive power from an electronic device by disconnecting the jack plug connector 363 from the head part 360 and connecting the jack plug connector 363 with an ear jack interface of the electronic device.

The present disclosure is not limited to the above examples because any jack plug connectors (or jack plug cable) having a connection structure for inserting into the ear jack interface of the electronic device can operate according to the present disclosure.

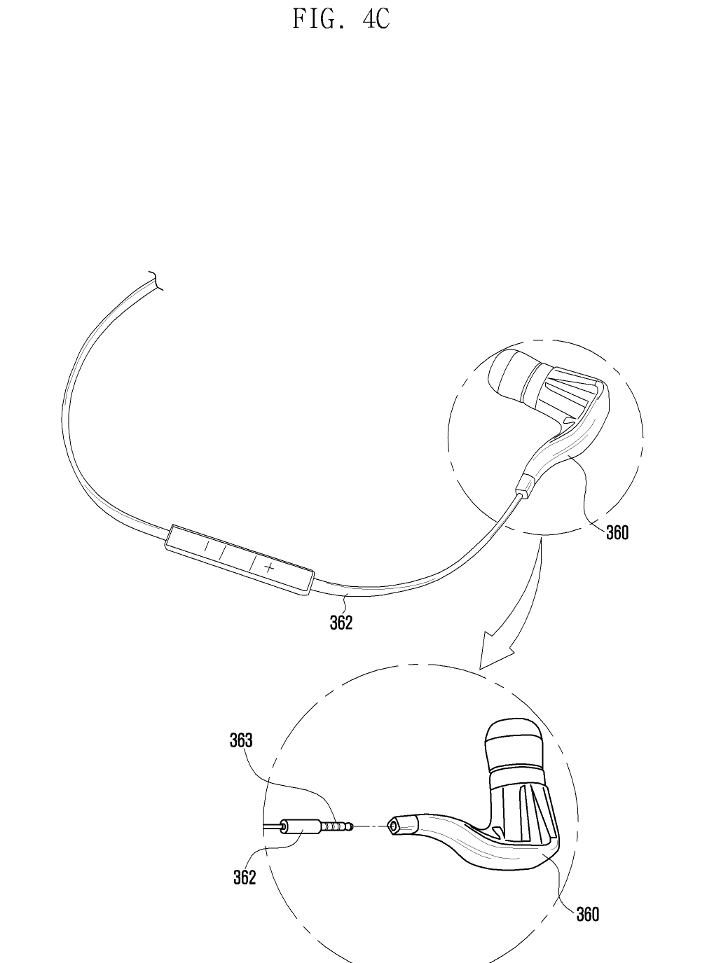

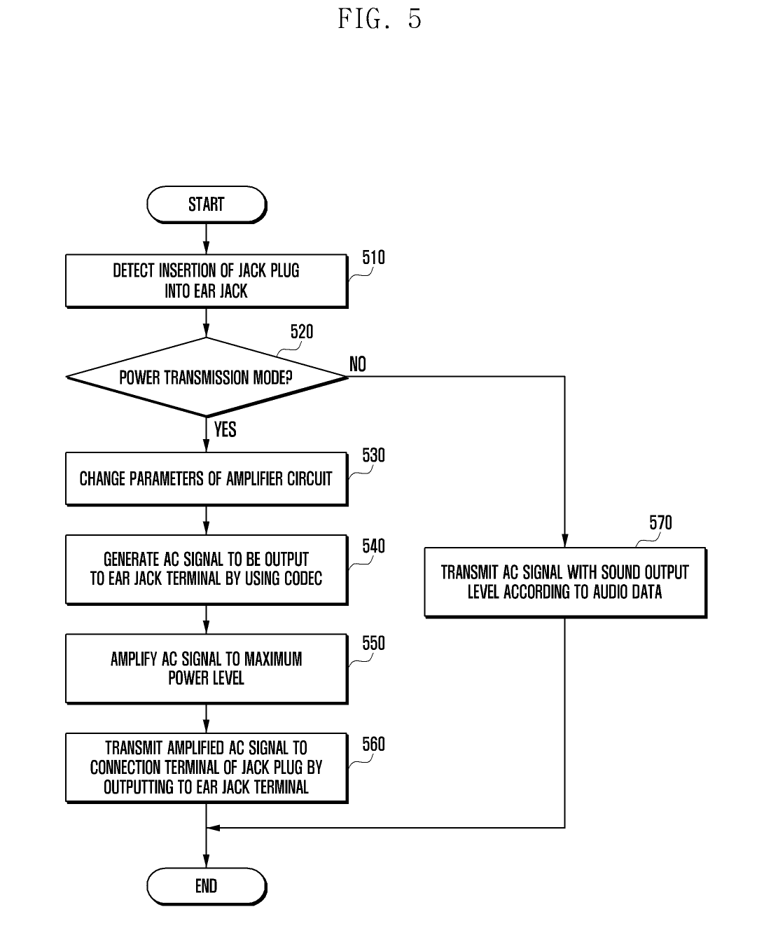

FIG. 5 is a flowchart illustrating a method for controlling a power signal in an electronic device according to one embodiment of the present disclosure.

Referring to FIG. 5, the control unit of the electronic device identifies whether a jack plug connected with an ear jack terminal is inserted into an ear jack interface at operation 510. For example, the electronic device can identify the insertion of the jack plug based on a voltage value (or resistance value) of a connection between the ear jack terminal and the connection terminal of the jack plug connector.

The control unit determines at operation 520 whether to operate in a power transmission mode.

According to one embodiment of the present disclosure, the control unit determines the electronic device is in the power transmission mode when the external device is coupled with the electronic device via the ear jack and also paired with the electronic device via a Bluetooth pairing, when an input signal is received from the external device through the ear jack, or when the ear jack includes at least two ear jack terminals, one ear jack terminal is coupled to the external device and other ear jack terminal is disconnected from the external device.

According to one embodiment of the present disclosure, the control unit can control a display unit in the electronic device to display information for turning the power transmission mode on or off.

In order to supply power to the external device when the electronic device is operating in the power transmission mode, the control unit changes a parameter of an amplifier so that a signal is amplified to a specific power level, for example the maximum power level allowed by the electronic device, at operation 530. The control unit generates an analog signal (AC) corresponding to an ear jack terminal by using an audio codec at operation 540. For example, the control unit can generate a signal corresponding to at least one of a left sound terminal and a right sound terminal.

The control unit controls the amplifier to amplify the analog signal generated by the audio codec to, for example, the maximum power level at operation 550 and controls to output the amplified analog signal to an ear jack terminal of an ear jack interface at operation 560.

Subsequently, the analog signal amplified to the maximum power level and output to the ear jack terminal of the ear jack interface can be transmitted to an external device, for example the Bluetooth device 200 through a connection terminal of an inserted jack plug. The external device can receive DC voltage power from a digital signal converted from the analog signal amplified.

In the meantime, if an external device connected by inserting a jack plug is connected with a conventional device such as an audio output device earphone or headset, so the electronic device is not operating in the power transmission mode, the control unit provides an analog signal with a sound output level corresponding to the audio data of the signal through an audio processing unit at operation 570.

The electronic device according to various embodiments of the present disclosure can transmit an analog signal with a corresponding sound output level to the ear jack interface by determining a sound output mode if the external device is connected by inserting a jack plug, and it can transmit an analog signal with a maximum power level to an external device through the ear jack interface by determining a power transmission mode if a specific condition is satisfied when inserting the jack plug.

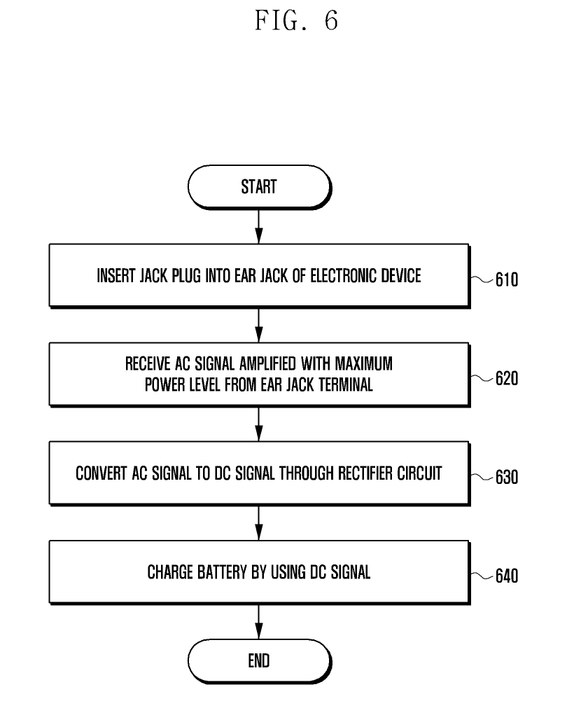

FIG. 6 is a flowchart illustrating a method for controlling a power signal in a Bluetooth device according to one embodiment of the present disclosure.

Referring to FIG. 6, the Bluetooth device according to one embodiment of the present disclosure detects a connection of the electronic device if a jack plug connector is inserted into the ear jack of the electronic device at operation 610. Similarly to the electronic device, the Bluetooth device 200 can detect a connection with the electronic device based on a voltage value between an ear jack terminal and a connection terminal of a jack plug included in the Bluetooth device.

The Bluetooth device receives an analog signal amplified to, for example, the maximum power level through the connection terminal of the jack plug connector connected to the ear jack terminal at operation 620.

The Bluetooth device converts the received analog signal to a digital signal through a rectifying circuit (or rectifier) at operation 630 and supplies power to charge a battery of the Bluetooth device by using the converted digital signal at operation 640.

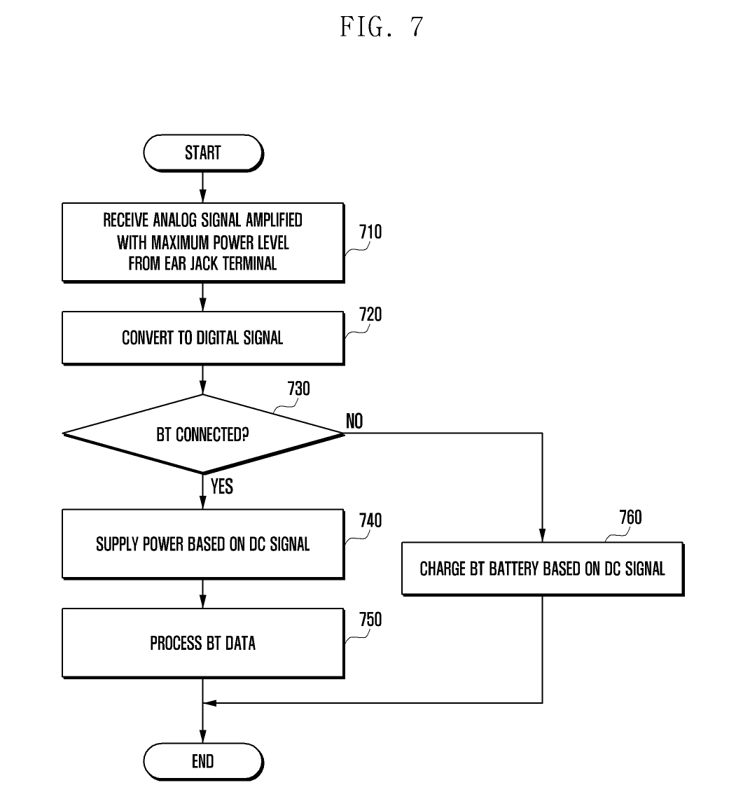

FIG. 7 is a flowchart illustrating a method for controlling a power signal in a Bluetooth device according to one embodiment of the present disclosure.

Referring to FIG. 7, if an electronic device is connected through an ear jack interface, the Bluetooth device according to one embodiment of the present disclosure receives an analog signal amplified to a maximum power level through a connection terminal of the jack plug connector connected to the ear jack terminal at operation 710.

The Bluetooth device converts the received analog signal to a digital signal through a rectifying circuit (or rectifier) at operation 720. The Bluetooth device identifies whether the electronic device is paired with the Bluetooth device at operation 730. If the electronic device is paired, the power supplied by the digital signal is used to power the Bluetooth device at operation 740. The Bluetooth device drives a Bluetooth module and processes Bluetooth data by using a signal transmitted by the electronic device through a connection terminal of a jack plug at operation 750.

If the electronic device is not paired with the Bluetooth device, the Bluetooth device goes into a non-operating mode and charges an internal battery of the Bluetooth device at operation 760.

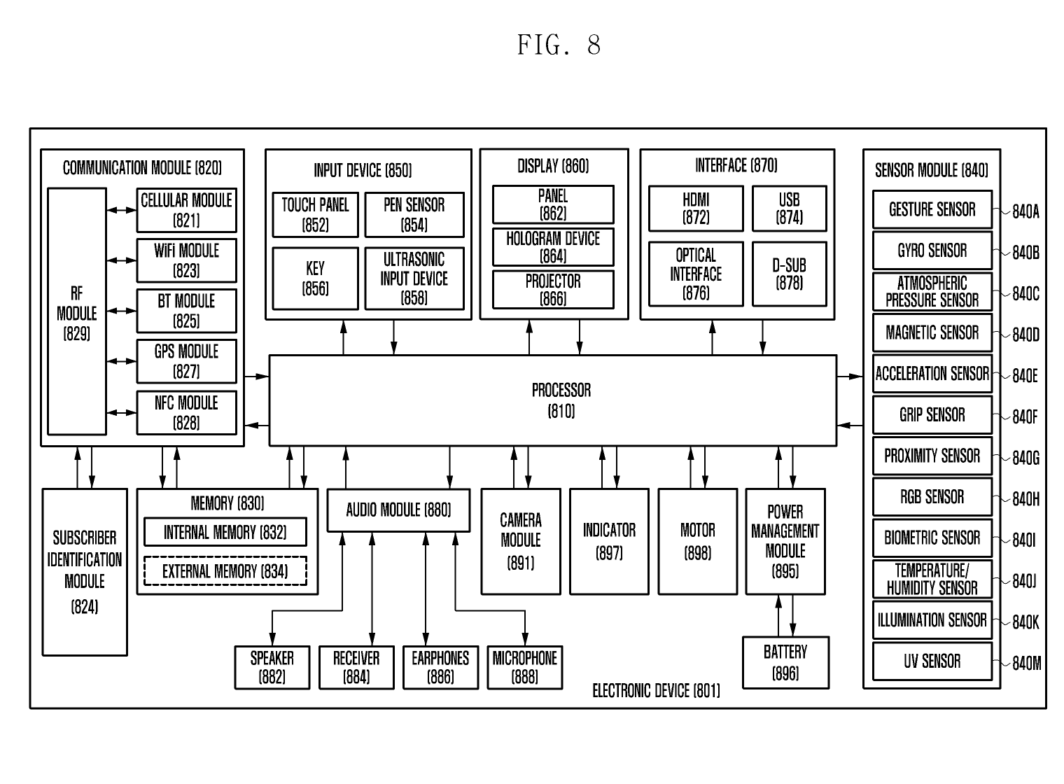

FIG. 8 is a block diagram of an electronic device 801 according to one embodiment of the present disclosure. The electronic device 801 may configure, for example, a whole or a part of the electronic device 100 illustrated in FIG. 1. Referring to FIG. 8, the electronic device 801 may include one or more Application Processors (APs) 810, a communication module 820, a Subscriber Identification Module (SIM) card 824, a memory 830, a sensor module 840, an input device 850, a display 860, an interface 870, an audio module 880, a camera module 891, a power managing module 895, a battery 896, an indicator 897, and a motor 898.

The AP 810 operates an operation system or an application program so as to control a plurality of hardware or software component elements connected to the AP 810 and execute various data processing and calculations including multimedia data. The AP 810 may be implemented by, for example, a System on Chip (SoC). According to an embodiment, the processor 810 may further include a Graphic Processing Unit (GPU).

The communication module 820 may transmit/receive data in communication between different electronic devices (for example, the electronic device and the server) connected to the electronic device 801 (for example, electronic device 100) through a network. According to an embodiment, the communication module 820 may include a cellular module 821, a WiFi module 823, a BlueTooth (BT) module 825, a Global Positioning System (GPS) module 827, a Near Field Communication (NFC) module 828, and a Radio Frequency (RF) module 829.

The cellular module 821 may provide a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 821 may distinguish and authenticate electronic devices within a communication network by using a subscriber identification module (for example, the SIM card 824). According to an embodiment, the cellular module 821 may perform at least some of the functions which can be provided by the AP 810. For example, the cellular module 821 may perform at least some of the multimedia control functions.

According to an embodiment, the cellular module 821 may include a Communication Processor (CP). Further, the cellular module 821 may be implemented by, for example, an SoC.

Although the components such as the cellular module 821 (for example, communication processor), the memory 830, and the power managing module 895 are illustrated as components separated from the AP 810 in FIG. 8, the AP 810 may include at least some (for example, cellular module 821) of the aforementioned components in one embodiment.

According to an embodiment, the AP 810 or the cellular module 821 (for example, communication processor) may load a command or data received from at least one of a non-volatile memory and other components connected to each of the AP 810 and the cellular module 821 to a volatile memory and process the loaded command or data. Further, the AP 810 or the cellular module 821 may store data received from at least one of other components or generated by at least one of other components in a non-volatile memory.

Each of the WiFi module 823, the BT module 825, the GPS module 827, and the NFC module 828 may include, for example, a process for processing data transmitted/received through the corresponding module. Although the cellular module 821, the WiFi module 823, the BT module 825, the GPS module 827, and the NFC module 828 are illustrated as blocks separated from other in FIG. 8, at least some (for example, two or more) of the cellular module 821, the WiFi module 823, the BT module 825, the GPS module 827, and the NFC module 828 may be included in one Integrated Chip (IC) or one IC package according to one embodiment. For example, at least some (for example, the communication processor corresponding to the cellular module 821 and the WiFi processor corresponding to the WiFi module 823) of the processors corresponding to the cellular module 821, the WiFi module 823, the BT module 825, the GPS module 827, and the NFC module 828 may be implemented by one SoC.

The RF module 829 may transmit/receive data, for example, an RF signal. Although not illustrated, the RF module 829 may include, for example, a transceiver, a Power Amp Module (PAM), a frequency filter, a Low Noise Amplifier (LNA) or the like. Further, the RF module 829 may further include a component for transmitting/receiving electronic waves over a free air space in wireless communication, for example, a conductor, a conducting wire or the like. Although the cellular module 821, the WiFi module 823, the BT module 825, the GPS module 827, and the NFC module 828 share one RF module 829, at least one of the cellular module 821, the WiFi module 823, the BT module 825, the GPS module 827, and the NFC module 828 may transmit/receive an RF signal through a separate RF module according to one embodiment.

The SIM card 824 may be a card including a subscriber identification module and may be inserted into a slot formed in a particular portion of the electronic device. The SIM card 824 may include unique identification information (for example, Integrated Circuit Card IDentifier (ICCID)) or subscriber information (for example, International Mobile Subscriber Identity (IMSI).

The memory 830 may include an internal memory 832 or an external memory 834. The internal memory 832 may include, for example, at least one of a volatile memory (for example, a dynamic RAM (DRAM), a static RAM (SRAM), a synchronous dynamic RAM (SDRAM), and the like), and a non-volatile Memory (for example, a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 832 may be a Solid State Drive (SSD). The external memory 834 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 834 may be functionally connected to the electronic device 201 through various interfaces. According to an embodiment, the electronic device 801 may further include a storage device (or storage medium) such as a hard drive.

The input device 850 may include a touch panel 852, a (digital) pen sensor 854, a key 856, or an ultrasonic input device 858. For example, the touch panel 852 may recognize a touch input in at least one type of a capacitive type, a resistive type, an infrared type, and an acoustic wave type. The touch panel 852 may further include a control circuit. In the capacitive type, the touch panel 852 can recognize proximity as well as a direct touch. The touch panel 852 may further include a tactile layer. In this event, the touch panel 852 may provide a tactile reaction to the user.

The input device 850 may include a touch panel 852, a (digital) pen sensor 854, a key 856, or an ultrasonic input device 858. For example, the touch panel 852 may recognize a touch input in at least one type of a capacitive type, a resistive type, an infrared type, and an acoustic wave type. The touch panel 852 may further include a control circuit. In the capacitive type, the touch panel 852 can recognize proximity as well as a direct touch. The touch panel 852 may further include a tactile layer. In this event, the touch panel 852 may provide a tactile reaction to the user.

The (digital) pen sensor 854 may be implemented, for example, using a method identical or similar to a method of receiving a touch input of the user, or using a separate recognition sheet. The key 856 may include, for example, a physical button, an optical key, or a key pad. The ultrasonic input device 858 is a device which can detect an acoustic wave by a microphone (for example, microphone 888) of the electronic device 801 through an input means generating an ultrasonic signal to identify data and can perform wireless recognition. According to an embodiment, the electronic device 801 may receive a user input from an external device (for example, computer or server) connected to the electronic device 801 by using the communication module 820.

The display 860 may include a panel 862, a hologram device 864, or a projector 866. The panel 862 may be, for example, a Liquid Crystal Display (LCD) or an Active Matrix Organic Light Emitting Diode (AM-OLED). The panel 862 may be implemented to be, for example, flexible, transparent, or wearable. The panel 862 may be configured by the touch panel 852 and one module. The hologram device 864 may show a stereoscopic image in the air by using interference of light. The projector 866 may project light on a screen to display an image. For example, the screen may be located inside or outside the electronic device 801. According to an embodiment, the display 860 may further include a control circuit for controlling the panel 862, the hologram device 864, or the projector 866.

The interface 870 may include, for example, a High-Definition Multimedia Interface (HDMI) 272, a Universal Serial Bus (USB) 274, an optical interface 876, or a D-subminiature (D-sub) 878. Additionally or alternatively, the interface 890 may include, for example, a Mobile High-definition Link (MHL) interface, a Secure Digital (SD) card/Multi-Media Card (MMC) (not shown), or an Infrared Data Association (IrDA) standard interface.

The audio module 880 may bi-directionally convert a sound and an electronic signal. The audio module 880 may process sound information input or output through, for example, a speaker 882, a receiver 884, an earphone 886, the microphone 288 or the like.

The camera module 891 is a device which can photograph a still image and a video. According to an embodiment, the camera module 891 may include one or more image sensors (for example, a front sensor or a back sensor), an Image Signal Processor (ISP) (not shown) or a flash (not shown) (for example, LED or xenon lamp).

The power managing module 895 may manage power of the electronic device 801. Although not illustrated, the power managing module 895 may include, for example, a Power Management Integrated Circuit (PMIC), a charger Integrated Circuit (IC), or a battery or fuel gauge.

The PMIC may be mounted to, for example, an integrated circuit or an SoC semiconductor. A charging method may be divided into wired and wireless methods. The charger IC may charge a battery and prevent over voltage or over current from being flowed from a charger. According to an embodiment, the charger IC may include a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier or the like may be added The battery fuel gauge may measure, for example, a remaining quantity of the battery 896, or a voltage, a current, or a temperature during the charging. The battery 896 may store or generate electricity and supply power to the electronic device 801 by using the stored or generated electricity. The battery 896 may include a rechargeable battery or a solar battery.

The indicator 897 may show particular statuses of the electronic device 801 or a part (for example, AP 810) of the hardware, for example, a booting status, a message status, a charging status and the like. The motor 898 may convert an electrical signal to a mechanical vibration.

Although not illustrated, the electronic device 801 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or an additional component may be further included. Also, some of the components of the electronic device according to various embodiments of the present disclosure may be combined to form a single entity, and thus may equivalently execute functions of the corresponding components before being combined.

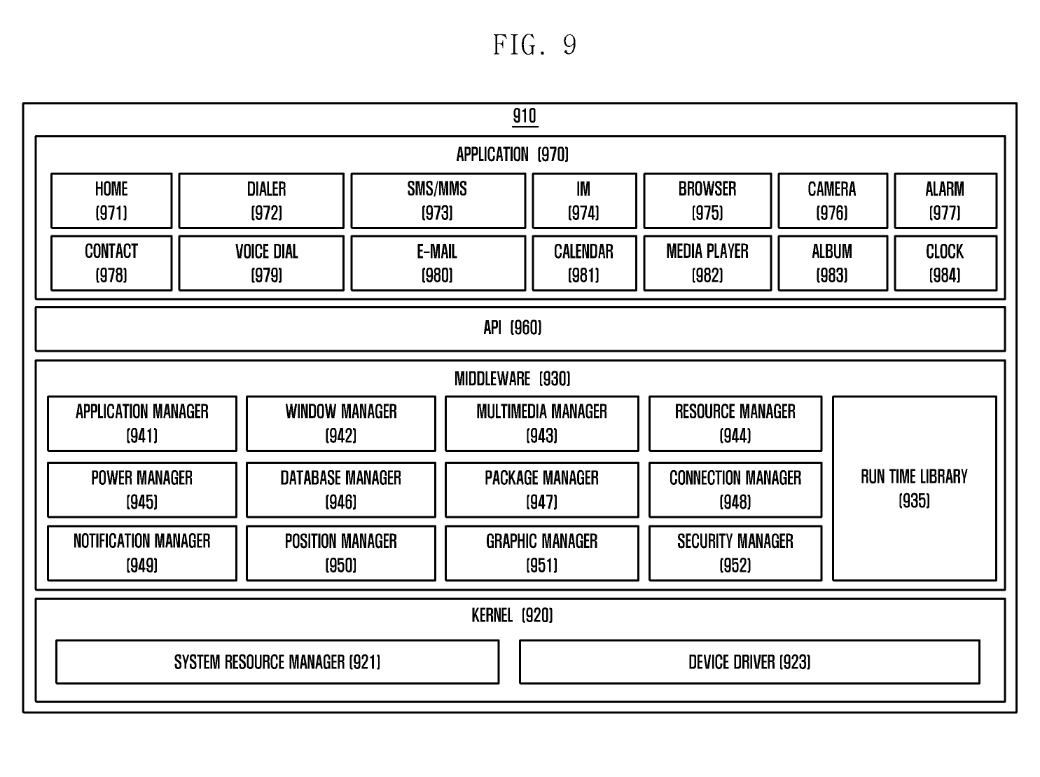

FIG. 9 is a block diagram of a programming module 300 according to an embodiment of the present disclosure. The programming module 900 may be included (stored) in the electronic device 100 illustrated in FIG. 1. At least some of the programming module 900 may be formed of software, firmware, hardware, or a combination of at least two of software, firmware, and hardware. The programming module 900 may be executed in the hardware to include an Operating System (OS) controlling resources related to the electronic device or various applications (for example, applications 970) driving on the OS. For example, the OS may be Android, iOS, Windows, Symbian, Tizen, Bada or the like. Referring to FIG. 9, the programming module 900 may include a kernel 910, a middleware 930, an Application Programming Interface (API) 960, or an application 970.

The kernel 910 may include a system resource manager 911 or a device driver 912. The system resource manager 911 may include, for example, a process manager 913, a memory manager 915, or a file system manager 917. The system resource manager 911 may perform a system resource control, allocation, or recall. The device driver 912 may include, for example, a display driver 914, a camera driver 916, a Bluetooth driver 918, a shared memory driver 920, a USB driver 922, a keypad driver 924, a WiFi driver 926, or an audio driver 928. Further, according to an embodiment, the device driver 912 may include an Inter-Process Communication (IPC) driver (not shown).

The middleware 930 may include a plurality of modules prepared in advance to provide a function required in common by the applications 970. Further, the middleware 930 may provide a function through the API 960 to allow the application 970 to efficiently use limited system resources within the electronic device. For example, as illustrated in FIG. 9, the middleware 930 may include at least one of a runtime library 935, an application manager 941, a window manager 942, a multimedia manager 943, a resource manager 944, a power manager 945, a database manager 946, a package manager 947, a connectivity manager 948, a notification manager 949, a location manager 950, a graphic manager 951, and a security manager 952.

The runtime library 935 may include, for example, a library module used by a complier to add a new function through a programming language while the application 970 is executed. According to an embodiment, the runtime library 935 may execute input and output, management of a memory, a function associated with an arithmetic function or the like.

The application manager 941 may manage, for example, a life cycle of at least one of the applications 970. The window manager 942 may manage GUI resources used on the screen. The multimedia manager 943 may detect a format required for reproducing various media files and perform an encoding or a decoding of a media file by using a codec suitable for the corresponding format. The resource manager 944 may manage resources such as a source code, a memory, or a storage space of at least one of the applications 970.

The power manager 945 may operate together with a Basic Input/Output System (BIOS) to manage a battery or power and provide power information required for the operation. The database manager 920F may manage generation, search, or change of a database to be used by at least one of the applications 970. The package manager 947 may manage an installation or an update of an application distributed in a form of a package file.

The connectivity manager 948 may manage, for example, a wireless connection such as WiFi or Bluetooth. The notification manager 949 may display or notify a user of an event such as an arrival message, an appointment, a proximity alarm or the like, in a manner that does not disturb the user. The location manager 950 may manage location information of the electronic device. The graphic manager 951 may manage a graphic effect provided to the user or a user interface related to the graphic effect. The security manager 952 may provide a general security function required for a system security or a user authentication. According to an embodiment, when the electronic device (for example, electronic device 100) has a call function, the middleware 930 may further include a telephony manager (not shown) for managing a voice of the electronic device or a video call function.

The middleware 930 may generate a new middleware module through a combination of various functions of the aforementioned internal component modules and use the generated new middleware module. The middleware 930 may provide a module specified for each type of operating system to provide a differentiated function. Further, the middleware 930 may dynamically delete some of the conventional components or add new components. Accordingly, some of the components described in the embodiment of the present disclosure may be omitted, replaced with other components having different names but performing similar functions, or other components may be further included.

The API 960 is a set of API programming functions, and may be provided with a different configuration according to an operating system. For example, in Android or iOS, a single API set may be provided for each platform. In Tizen, two or more API sets may be provided.

The applications 970 may include, for example, a preloaded application or a third party application.

At least some of the programming module 900 may be implemented by a command stored in a computer-readable storage medium. When the command is executed by one or more processors (for example, processor 810), the one or more processors may perform a function corresponding to the command. The computer-readable storage medium may be, for example, the memory 830. At least some of the programming module 900 may be implemented (for example, executed) by, for example, the processor 810. At least some of the programming module 900 may include, for example, a module, a program, a routine, sets of instructions, or a process for performing one or more functions.

Names of components of the programming module (for example, programming module 900) according to the present disclosure may vary depending on a type of operating system. Further, the programming module according to the present disclosure may include one or more of the aforementioned components, omit some of the components, or further include other additional components.

An electronic device and a method for controlling a power signal in the electronic device according to various embodiments of the present disclosure can charge a battery or perform a communicating operation with low power according to the requirement by transmitting an analog signal amplified to a power level, for example a maximum power level through an ear jack and an ear jack plug connector.

An electronic device according to various embodiments of the present disclosure can provide a signal for supplying power to an external device through an ear jack installed in the electronic device without using a separate charging adaptor. Therefore, when operating an electronic device such as a Bluetooth headset or earphone whose battery becomes frequently discharged, the inconvenience of frequently recharging a battery can be removed by recharging the battery without a separate charging device.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, or a combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for.”

What is claimed is:

1. An electronic device comprising:
a communication module configured to communicate wirelessly with an external device;
an ear jack configured to include at least one ear jack terminal;
an audio processing unit configured to process an audio signal for transmission via the ear jack; and
a control unit configured to:
detect a coupling with the external device through the ear jack,
determine whether the electronic device is in a power transmission mode,
control the audio processing unit to generate an ear jack signal when the electronic device is in a power transmission mode,
output the ear jack signal by amplifying the ear jack signal so that power is supplied to the coupled external device, and
output the audio signal to the ear jack terminal when the electronic device is not in a power transmission mode.

2. The electronic device of claim 1, wherein the control unit determines the electronic device is in the power transmission mode when the external device is coupled with the electronic device via the ear jack and also paired with the electronic device via a Bluetooth pairing, when an input signal is received from the external device through the ear jack, or when the ear jack includes at least two ear jack terminals, one ear jack terminal is coupled to the external device and other ear jack terminal is disconnected from the external device.

3. The electronic device of claim 1, wherein the control unit controls a display unit in the electronic device to display information for turning the power transmission mode on or off.

4. The electronic device of claim 1, wherein the control unit controls a parameter of an amplifier included in the audio processing unit to amplify the ear jack signal.

5. The electronic device of claim 1, wherein the control unit controls to generate the ear jack signal using an audio codec included in the audio processing unit and to amplify the ear jack signal.

6. A Bluetooth electronic device, the Bluetooth electronic device comprising:
a Bluetooth module configured to transmit and receive Bluetooth communication data;
a jack connector configured to include at least one terminal for coupling to an ear jack of an external device and to receive an analog ear jack signal or an audio signal;
a rectifying circuit configured to convert the analog ear jack signal to a digital signal; and
a processing unit configured to power the Bluetooth module or charge a battery of the Bluetooth electronic device using power supplied by the digital signal.

7. The Bluetooth electronic device of claim 6, wherein the processing unit is further configured to determine a connection state of a Bluetooth pairing between the Bluetooth electronic device and the external device, and to power the Bluetooth module with power supplied by the digital signal when the Bluetooth pairing is enabled, and to charge the battery of the Bluetooth electronic device when the Bluetooth pairing is disabled.

8. A method for controlling a power signal in an electronic device using an ear jack having at least one ear jack terminal, the method comprising:
detecting a coupling with an external device through the ear jack;
determining whether the electronic device is in a power transmission mode;
generating an ear jack signal to output to the ear jack terminal when the electronic device is in a power transmission mode; outputting the generated ear jack signal to the ear jack terminal by amplifying the ear jack signal; and
outputting an audio signal to the ear jack terminal when the electronic device is not in a power transmission mode.

9. The method of claim 8, wherein determining whether the electronic device is in the power transmission mode comprises a determination of when the external device is coupled with the electronic device via the ear jack and also paired with the electronic device via a Bluetooth pairing, when an input signal is received from the external device through the ear jack, or when the ear jack includes at least two ear jack terminals, one ear jack terminal is coupled to the external device and other ear jack terminal is disconnected from the external device.

10. The method of claim 8, further comprising displaying information for turning the power transmission mode on or off.

11. A method for controlling a power signal in a Bluetooth electronic device using an ear jack connector, the method comprising:
receiving an analog signal or an audio signal via the ear jack connector from an external device;
converting the received analog signal to a digital signal with a rectifying circuit; and
driving a Bluetooth module of the Bluetooth electronic device or charging a battery of the Bluetooth electronic device using power supplied by the digital signal.

12. The method of claim 11, further comprising:
determining a connection state of Bluetooth pairing between the Bluetooth electronic device and the external device;
supplying power to the Bluetooth module using power supplied by the digital signal when the external device is paired with the Bluetooth device; and
charging the battery of the Bluetooth electronic device using power supplied by the digital signal when the external device is not paired with the Bluetooth device.

13. An Bluetooth electronic device, the Bluetooth electronic device comprising:
a Bluetooth module configured to transmit and receive Bluetooth communication data with the Bluetooth electronic device;
a jack connector configured to include at least one connection terminal for receiving an amplified analog signal or an audio signal;
a rectifying circuit configured to convert the analog signal to a digital signal; and
a processing unit configured to charge a battery of the Bluetooth electronic device using power supplied by the digital signal.

14. The electronic device of claim 13, wherein the Bluetooth electronic device is at least one of a Bluetooth headset, Bluetooth earphone, and Bluetooth speaker.

15. The electronic device of claim 13, wherein the processing unit is further configured to determine a connection state of a Bluetooth pairing of the Bluetooth electronic device, and to power the Bluetooth module with power supplied by the digital signal when the Bluetooth pairing is enabled, and to charge the battery of the Bluetooth electronic device when the Bluetooth pairing is disabled.

16. The electronic device of claim 13, wherein the jack connector is detachable from the Bluetooth electronic device.
